(19) United States
(12) Patent Application Publication
(10) Pub. No.: US 2017/0150206 A1
(43) Pub. Date: May 25, 2017

(54) ONLINE VIDEO PLAYER AND ITS METHOD

(71) Applicants: LE HOLDINGS (BEIJING) CO., LTD., Beijing (CN); LECLOUD COMPUTING CO., LTD., Beijing (CN)

(72) Inventors: Yuefeng HU, Beijing (CN); Di HOU, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,415

(22) Filed: Aug. 31, 2016

Related U.S. Application Data
(63) Continuation of application No. PCT/CN2016/083199, filed on May 24, 2016.

(30) Foreign Application Priority Data
Nov. 24, 2015 (CN) 201510822222.6

(51) Int. Cl. H04N 21/438; H04N 21/2187; H04N 21/434; H04N 21/643; H04N 21/44; H04N 21/845; H04N 21/2387

(52) U.S. Cl. CPC H04N 21/4383; H04N 21/8456; H04N 21/2187; H04N 21/2387; H04N 21/643; H04N 21/44; H04N 21/434; H04L 65/4076

(57) ABSTRACT

Disclosed is an online live video player including a player interface component, a protocol switching component and a player control component implemented by a processor. The player interface component receives broadcast time adjusting instructions, the protocol switching component decides whether to switch a current first streaming media transmission protocol to a second streaming media transmission protocol based on the broadcast time adjusting instructions, and the player control component provides a live broadcast or playback according to the streaming media transmission protocol identified by the protocol switching component. The first streaming media transmission protocol is selected from a streaming media transmission protocol for live broadcast or a streaming media transmission protocol for playback, the second streaming media transmission protocol being the other one. Also disclosed is a video playing method which provides good real-time characteristics and reduce delay time in the existing technology by switching of dual protocols.

### CROSS REFERENCE TO RELATED APPLICATIONS

This application is a continuation of International Application No. PCT/CN2016/083199, filed on May 24, 2016, which is based upon and claims priority to Chinese Patent Application No. 201510822222.6, filed on Nov. 24, 2015, the entire contents of which are incorporated herein by reference.

### TECHNICAL FIELD

The disclosure relates to the field of video, specifically involving an online video player, a method for online video playing and a non-transitory computer-readable storage medium.

### BACKGROUND

With the development of computer technology, online video player is usually a kind of streaming media player to be broadcast in the network through streaming media technology. Streaming media technology is a data transmission technology through which a series of media data packet is compressed in sequence and sent to the terminal. The terminal receives multiple streaming media data packets in sequence like an assembly line and decompresses them in turn to play. Compared with the ordinary play mode of “download before play”, streaming media technology can achieve online play of streaming audio and video files. Online video player uses common streaming media transmission protocol in the process of playing such as smooth streaming protocol, MMS protocol and HLS, HTTP protocol, RTSP protocol, RTMP protocol and Mpeg DASH protocol, etc., of which the most commonly used are RTMP protocol and HLS protocol.

Real Time Messaging Protocol (RTMP) is a kind of network Protocol used for real-time data communication, mainly used in the Flash/AIR platform and supporting of audio and video and data communication between streaming media and interaction server of the RTMP Protocol, and it is often used for watching online live videos. Watching videos through RTMP protocol has an advantage of better real-time performance. However, the disadvantage is that in the process of live broadcast one cannot playback to the previous content.

HTTP Live Streaming (HLS), a kind of streaming media transmission protocol based on hypertext transfer protocol HTTP is implemented by Apple Inc., HTTP Live Streaming divides huge continuous media data into many small files for transmitting, which caters to file transmitting of the web server. HTTP Live Streaming adopts a constantly updated lightweight index file to control download and play of the divided small media files and realize Live broadcast and on-demand broadcast of streaming media. HTTP Live Streaming is mainly used in iOS, for providing live audio and video broadcast and on-demand methods for iOS devices such as iPhone and iPad. Compared with common live streaming protocol, such as RTMP protocol, RTSP protocol, MMS, etc., the maximum difference of HLS live broadcast is that the data flow attained from the live broadcast client terminal is not complete. HLS protocol saves live broadcast data stream as continuous and short time long media files (MPEG-TS format) on the Server, and the Client continually downloads and plays these small files, because the Server always generates the latest live data into new small files. In this case, the Client just keeps playing the files in sequence obtained from the Server, and live broadcast is realized. Thereby we can speculate HLS realizes the live broadcast through on demand technical way. However, the technical characteristics of HLS protocol lead to defects of longer delay time. Its delay time is always longer than that of ordinary streaming media protocols.

At present, the delay time of online video player is controlled within 3 seconds in order to get strong real-time performance of the player for broadcasting, and RTMP protocol is adopted. However the online video player using RTMP protocol has a disadvantage of not looking back to watch the previous content in the process of live broadcast.

In order to playback, HLS protocol video player must be used, but delay time of the player is very long in the process of live broadcast, usually at least more than 8 seconds, which causes serious influence on the video broadcast.

### SUMMARY

One object of the present disclosure is to provide an online video player, its operation methods and a non-transitory computer-readable storage medium, which ameliorate one or more problems of the prior art, such as failure to play back by using streaming media live broadcast protocol, and bigger delay in live broadcasting or looking back using streaming media on-demand broadcasting protocol, thereby realizes switchover between the protocols to watch live broadcast and playback.

According to an aspect of the present disclosure, there is provided an online live video player. The online live video player having at least one processor, a memory in electronic communication with the processor and instructions stored in the memory, includes a player interface component, a protocol switching component and a player control component. The player interface component is implemented by the at least one processor and configured to receive broadcast time adjusting instructions. The protocol switching component cooperates with the player interface component and is implemented by the at least one processor and configured to identify whether to switch the current to a first streaming media transmission protocol or to a second streaming media transmission protocol based on the broadcast time adjusting instructions. The player control component is implemented by the at least one processor and configured to provide a live broadcast or playback according to the streaming media transmission protocol identified by the protocol switching component, wherein, the first streaming media transmission protocol is selected from a streaming media transmission protocol for live broadcast or a streaming media transmission protocol for playback, the second streaming media transmission protocol being the other one.

According to another aspect of the present disclosure, there is also provided an method for online live video playing. The method includes the following: at an online live video player,
streaming media transmission protocol broadcast video based on live broadcast;
receiving broadcast time adjusting instructions;
switching a streaming media transmission protocol for live broadcast to a streaming media transmission protocol for playback, when the time point of the broadcast time adjusting instruction is earlier than the live broadcast point; and
playing back the video based on the streaming media transmission protocol for playback.

According to yet another aspect of the present application, there is further provided a non-transitory computer-readable storage medium storing executable instructions that used to execute any one of methods of the present application as described above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a structure schematic diagram of a play mode of the online video player of the present disclosure in accordance with one embodiment.

FIG. 2 illustrates a structure schematic diagram of terminal equipment or a server computer system of the present disclosure in accordance with another embodiment.

FIG. 3 illustrates a flow diagram of a play method of the online video player of the present disclosure in accordance with an embodiment.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

It should be noted that, embodiments of the present application and the technical features involved therein may be combined with each other in case they are not conflict with each other.

The present application can be applied in various general or specialized computer system or configuration, such as personal computer, server computer, hand-held device or portable device, tablet device, multi-processor system, microprocessor based system, set top box, programmable consuming electronic device, network PC, small computer, mainframe computer, and distributed computer environment including the above system or devices, etc.

The present application can be described in the context of computer executable instructions, such as program module, which can be executed by a computer. Generally, a program module includes routines, procedure, object, assemblies, and data structure, etc. for carrying out specific task or implementing specific abstract data type. The application can also be implemented in a distributed computer environment in which the task is performed by remote devices connected through communication network. In the distributed computer environment, the program module can be put in a storage mediums including memory device of the local and remote computer.

Finally, it should also be noted that, wordings like first and second are merely for separating one entity or operation from the other, but not intended to require or imply a relation or sequence among these entities or operations. Further, terms like “comprise”, “comprising”, and the like are to be construed as including not only the elements described, but also those elements not specifically described, or further comprising elements which are essential to such process, method, article or device. Unless the context clearly requires, throughout the description and the claims, elements defined by recitation with “comprising . . . ” should not be construed as exclusive from the process, method, article or device comprising said elements of other equivalent elements.

FIG. 1 illustrates a structure schematic diagram of play mode of the online video player of the present disclosure in accordance with one embodiment. The online video player of the present disclosure includes a player interface component 101, a protocol switching component 102, and a player control component 103. The player interface component 101 is used for receiving adjust instructions of broadcast time. The protocol switching component 102 is based on adjust instructions of broadcast time received by the player interface component 101 to determine/identify whether to switch a current first stream media transmission protocol into a second stream media transmission protocol. The player control component 103 conducts live broadcasting or playbacks through the streaming media transmission protocol determined based on the result determined by the protocol switching component 102. The first stream media transmission protocol is selected from one stream media transmission protocol used for live broadcast or playback, and the second stream media transmission protocol is selected from another stream media transmission protocol used for live broadcast or playback.

In an embodiment, functions of the player interface component 101 are realized through input/output devices, such as a keyboard, a mouse, etc. The protocol switching component 102 is realized by establishing an RTMP connection with a server for live streaming media transmission protocol use. The player control component 103 supports video de-multiplexing, decoding and rendering etc. to show the received video files.

In the embodiment shown in FIG. 1, the first streaming media transmission protocol is a streaming media transmission protocol based on the RTMP protocol, and the second streaming media transmission protocol is a streaming media transmission protocol based on based on the HTTP protocol. The streaming media transmission protocol based on the RTMP protocol has stronger real-time performance and the streaming media transmission protocol based on the HTTP protocol, such as HLS protocols, can play faster and have less delay time.

Furthermore, in the embodiment shown in FIG. 1, if the current first streaming media transmission protocol is used for live streaming media transmission protocol, protocol switching component 102 is used for keeping the first media transmission protocol unchanged when the timing of broadcast time adjust instruction is later than or to the same as that of the live broadcasting of a video, and for switching the first streaming media transmission protocol into the second streaming media transmission protocol if the timing of the broadcast time adjust instruction is earlier than the live video time. In this embodiment, determining of playback starting point and the process of switching protocol is combined, thereby saving the switching time.

Additionally, in the embodiment shown in FIG. 1, when the current first streaming media transmission protocol is used for playback streaming media transmission protocol, the protocol switching component 102 is used for keeping the first media transmission protocol unchanged if the timing of the broadcast time adjust instruction of the live video, and for switching the first streaming media transmission protocol into the second streaming media transmission protocol if the timing of the broadcast time adjust instruction is later than or the same as the live video time.

In an embodiment, as long as the play timing of a user's control of the interface component is later than the live broadcast timing, streaming media transmission protocol used for playback can be switched into streaming media transmission protocol for live broadcast, thus the user can switch to live broadcast mode to watch live video without knowing the precise play timing of the live video.

Further, in an embodiment, the player control component 103 is also used in such a way that, when playing timing of adjust instruction falls within the front and rearr key frames of code stream section of a playback video, de-multiplexing may be started from the front key frames of the code stream section, decoding and rendering can be started at the playing timing of the adjust instruction. This embodiment can pinpoint a user's choice of time for play.

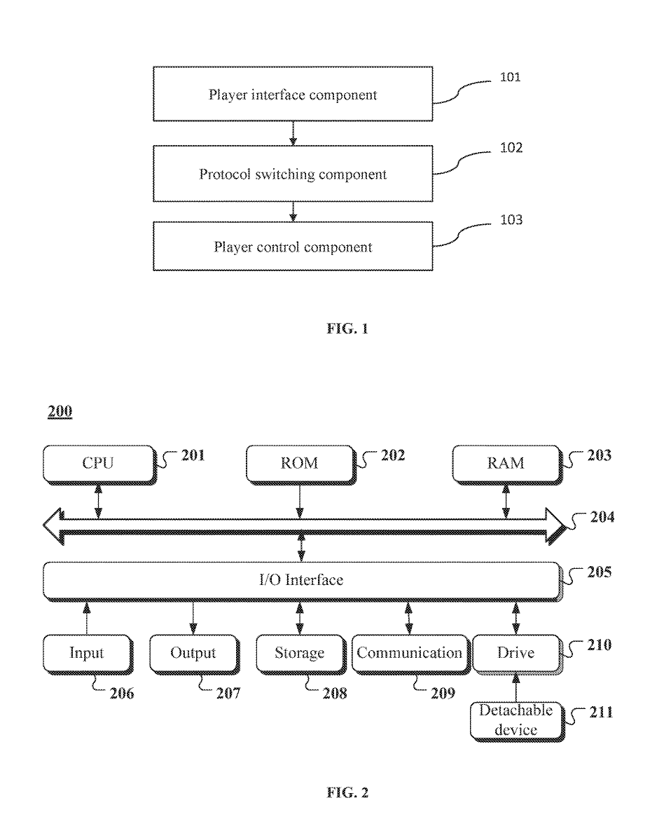

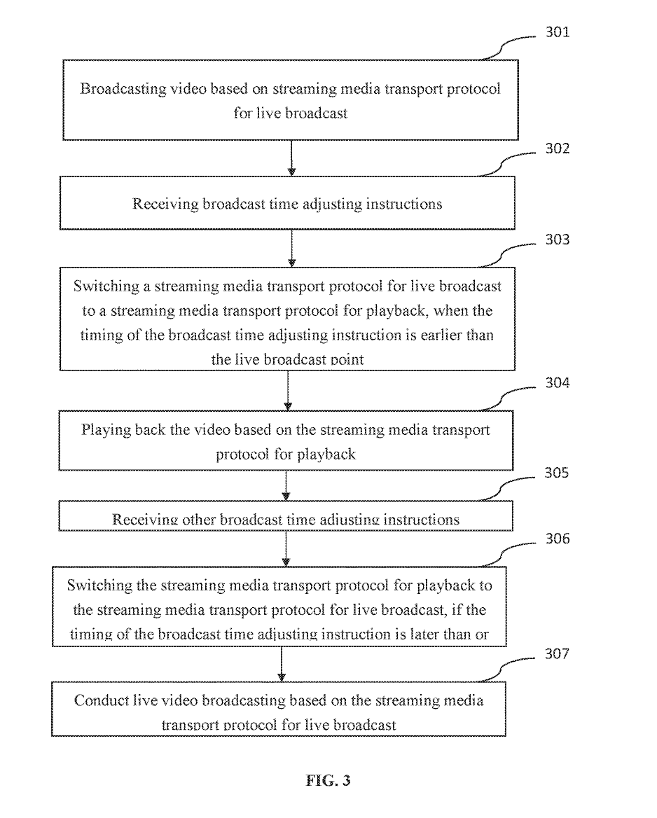

FIG. 2 illustrates a structure schematic diagram of terminal equipment or a server computer system 200 (hereinafter known as system) of the present disclosure in accordance with another embodiment. The system 200 includes a central processing unit (CPU) 201, which can be uploaded according to a process of read-only memory (ROM) 202 or a storage section 208 into the process of random access memory (RAM) 203 for performing a variety of appropriate actions and processing. In RAM 203 a variety of programs and data required for operation of the system 200 are stored. CPU 201, ROM 202 and RAM 203 are connected with each other through a main bus 204. An Input/output (I/O) interface 205 is also connected to the main bus 204.

The components that are connected to the I/O interface 205 include an input port 206 of a keyboard and/or a mouse, an output port 207 of cathode ray tube (CRT), a liquid crystal display (LCD) and speakers, a storage section 208 of a hard disk, and a communication port 209 of the network interface card of LAN card and modem. The communication port 209 performs communication processing through the network such as the Internet. A drive 210 is connected to the I/O interface 205 according to the need. A removable media 211 such as disks, optical disks, magneto-optical disks, semiconductor, memory, etc., is installed on the drive 210 as per requirement, which can be installed with the help of a computer process read from it into the storage section 208 as per requirement.

FIG. 3 of the accompanying drawing illustrates a flow diagram of the play methods of the online video player of the present disclosure in accordance with an embodiment. The online video broadcast method as shown in FIG. 3 can be systematically implemented based on the online video player illustrated in FIG. 1. As shown in FIG. 3, the online live video player method includes:

S301: streaming media transmission protocol broadcast video based on live broadcast;

S302: receiving broadcast time adjusting instructions;

S303: switching a streaming media transmission protocol for live broadcast to the streaming media transmission protocol for playback, when the time point of the playing time of adjusts instructions is earlier than that of live broadcast; and

S304: playing back/looking back the video based on the streaming media transmission protocol which is used for look-back/playback.

In an embodiment, the starting time of playback and the process of switching protocol are combined, saving the switching time.

According to the online live video playing method of the present application, through the use of switching of the two protocols, namely, a streaming media transmission protocol for live broadcast is used during living broadcasting, and a streaming media transmission protocol for playback is used at the time of playback, thus not only the use of good real-time characteristic of streaming media real-time transmission protocol in live broadcast can be satisfied, but also the delay time of playback of live broadcast in the existing technology can be reduced, thereby solving the dual requirements of real-time broadcast and playback at any time.

In an embodiment, the first protocol is an RTMP based streaming media transmission protocol, and the second protocol is HTTP protocol based streaming media transmission protocol.

In an embodiment, the player can provide a good performance of live broadcast by using the RTMP based streaming media transmission protocol, and by using HTTP protocol based streaming media transmission protocol, such as HLS protocol for playback, a fast playing with less delay can also be achieved.

Further, as illustrated in FIG. 3, the method further includes, after step S304: Playing back the video based on the streaming media transmission protocol for playback, the following steps:

S305: Receiving other broadcast time adjusting instructions;

S306: Switching the streaming media transmission protocol for playback to the streaming media transmission protocol for live broadcast, if a timing of the other broadcast time adjusting instruction is later than or to the same as that of the live broadcast point; and

S307: Live broadcasting the video based on the streaming media transmission protocol for live broadcast.

In this embodiment, as long as the timing of a user's control interface component is later than live broadcast time, streaming media transmission protocol for playback can be switched into streaming transmission protocol for live broadcast, which allows the user to switch to live video broadcast mode to watch the live video without knowing the precise timing of the live video.

Referring again to FIG. 3, according to another embodiment, during the live broadcasting of video based on the streaming media transmission protocol for live broadcast, when the timing of the playing time adjust instruction falls within the front and rear key frames of code stream section, de-multiplexing begins from the front key frame of the code stream section, and decoding and rendering begin on the playing time of adjust instruction. This embodiment can pinpoint the user's choice of time for play.

It should be noted that the aforementioned method examples are expressed as a series of actions merge for simple descriptions, but the technicians in the field ought to realize that, the disclosure is not limited by the described action sequence, because according to the disclosure, some steps can be carried out disorderly or simultaneously. Furthermore, the technicians in the field also ought to realize that the examples described in the specification are preferred examples, the involved actions and module may be not necessarily required by the disclosure.

In the examples above, each embodiment is given different stress in descriptions. Those contents without detailed description in an embodiment can be referred to in other embodiments for relevant description.

Relevant function module of the above embodiments can be realized by means of hardware processor.

In an embodiment, the RTMP protocol is used in live broadcast and online video player and its operation methods use HLS protocol as examples to further explain the working in the disclosure.

When a user clicks on live shows, the player, upon receiving the request, request to the server for establishing an RTMP connection. After the connection is established, the server sends the video of the live show, and caches the video. The player control component 103 parses and plays the video, including the processes of video de-multiplexing, decoding, and rendering.

When the user inputs a playing time adjust instruction through player interface component 101, such as by dragging player progress bar to a certain position through the mouse or inputting specific time through the input/output devices such as keyboard for playing back of the current live video, the protocol switching component 102 adjusts the timing of the instructions according to broadcast time to determine whether the user wants to play back, that is, whether to switch the current RTMP protocol to the HLS protocol. If the timing of the time adjust instruction is later than or to the same as the timing of the live video, then the player keeps streaming media transmission protocol unchanged. If the timing of the playing time adjust instruction is earlier than the timing of the live video, the protocol switching component 102 will switch the RTMP protocol to the HLS protocol, and request an HLS address according to the timing of the playing time adjust instruction. The player control component 103 parses and broadcasts the corresponding video based on the HLS address. Further, if the timing of the playing time adjust instruction falls on the front and back key frames of a code stream section of the playback video, then the player control component 103 begins de-multiplex from the front key frame of code stream section, and begins decoding and rendering from the timing of the playing time adjust instruction.

When the user finishes playback, he/she can determine the next start time of the playing by dragging the progress bar in the player to a certain position or by inputting a specific playing time to choose playing live video or other period of video playback.

If the user drags the progress bar to the timing through e.g. a mouse, or inputs through a keypad a timing which is later than the timing (inclusive) of the live show, the protocol switching component 102 switches the current HLS protocol to the RTMP protocol for the user to watch live video. In the process, the protocol switching component 102 requests for the RTMP connection and live broadcast address. The player control component 103 parses and plays the video according to the live broadcast address.

If the user drags through e.g. a mouse the progress bar to the timing, or inputs through a keypad a timing which is earlier than the timing (inclusive) of the live show, it means that the user does not request the latest live broadcast time, so it is unnecessary for the protocol switching component 102 to switch the HLS protocol to the RTMP protocol. In this case, the protocol switching component 102 continues to request the HLS address according to the timing of the playing time adjust instruction input by the user. The player control component 103 parses and plays the corresponding video based on the HLS address.

An embodiment of the present application also provides a non-transitory computer-readable storage medium storing executable instructions that used to execute any one of methods of the present application as described above.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present application, but not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. An online live video player having at least one processor, a memory in electronic communication with the processor and instructions stored in the memory, comprising:
a player interface component implemented by the at least one processor and configured to receive broadcast time adjusting instructions;
a protocol switching component cooperating with said player interface component, implemented by the at least one processor and configured to determine whether to switch a first streaming media transmission protocol to a second streaming media transmission protocol based on said broadcast time adjusting instructions; and
a player control component implemented by the at least one processor and configured to provide live broadcast or playback according to a streaming media transmission protocol determined by said protocol switching component,
wherein said first streaming media transmission protocol is one of a streaming media transmission protocol for live broadcast and a streaming media transmission protocol for playback, said second streaming media transmission protocol is the other of the streaming media transmission protocol for live broadcast and the streaming media transmission protocol for playback.

2. The online live video player as claimed in claim 1, wherein the protocol switching component is further configured to:
keep said first streaming media transmission protocol unchanged if said first streaming media transmission protocol is the streaming media transmission protocol for live broadcast, and timing of said protocol switching component for the broadcast time adjusting instruction is later than or equal to a time of the live video; and
switch said first streaming media transmission protocol to said second streaming media transmission protocol if timing of the broadcast time adjusting instructions is earlier than the time of the live video of a described video.

3. The online live video player as claimed in claim 1, wherein said protocol switching component implemented by the at least one processor is further configured to
keep said first streaming media transmission protocol unchanged when timing of broadcast time adjusting instruction is earlier than the time of the live video, if the first streaming media transmission protocol is the streaming media transmission protocol for playback; and
switch said first streaming media transmission protocol to said second streaming media transmission protocol when the timing of broadcast time adjusting instruction is later than or equal to the time of the live video.

4. The online live video player as claimed in claim 2, wherein said player control component is further configured to conduct a de-multiplexing from a front key frame of a code stream section, and conduct decoding and rendering from a timing of the broadcast time adjusting instruction when the timing of the broadcast time adjusting instruction falls in between the front and rear key frames of a code stream section for a playback video.

5. The online live video player as claimed in claim 1, wherein said streaming media transmission protocol for live broadcast is the streaming media transmission protocol based on RTMP protocol, and said streaming media transmission protocol for playback is the streaming media transmission protocol based on HTTP protocol.

6. A method for online live video playing comprising, at an online live video player,
broadcasting video based on a streaming media transmission protocol for live broadcast;
receiving a broadcast time adjusting instruction;
switching the streaming media transmission protocol for live broadcast to a streaming media transmission protocol for playback, when the timing of the broadcast time adjusting instructions is earlier than a live broadcast point; and
playing back the video based on the streaming media transmission protocol for playback.

7. The method as claimed in claim 6, further comprising, after playing back the video based on the streaming media transmission protocol for playback,
receiving other broadcast time adjusting instructions;
switching the streaming media transmission protocol for playback to the streaming media transmission protocol for live broadcast, if a timing of said other broadcast time adjusting instruction is later than or equal to the live broadcast point; and
conducting live video broadcasting based on the streaming media transmission protocol for live broadcast.

8. The method as claimed in claim 7, wherein said step of playing back the video based on the streaming media transmission protocol for playback further comprises:
when the timing of the broadcast time adjusting instruction falls within front and rear key frames of a code stream section of a playback video, de-multiplexing from the front key frame of the code stream section, and decoding and rendering from the timing of the broadcast time adjusting instruction.

9. The method as claimed in claim 8, wherein said step of streaming media transmission protocol for broadcast uses the streaming media transmission protocol based on RTMP protocol, and said step of streaming media transmission protocol for playback uses the streaming media transmission protocol based on HTTP protocol.

10. A non-transitory computer-readable storage medium storing executable instructions that, when executed by an online live video player, cause the online live video player to:
broadcast video based on a streaming media transmission protocol for live broadcast;
receive a broadcast time adjusting instruction;
switch the streaming media transmission protocol for live broadcast to a streaming media transmission protocol for playback, when the timing of the broadcast time adjusting instructions is earlier than the live broadcast point; and
play back the video based on the streaming media transmission protocol for playback.

11. The non-transitory computer-readable storage medium according to claim 10, wherein the executable instructions, when executed by an online live video player, further cause the online live video player to:
after playing back the video based on the streaming media transmission protocol for playback,
receive other broadcast time adjusting instructions;
switch the streaming media transmission protocol for playback to the streaming media transmission protocol for live broadcast, if a timing of said other broadcast time adjusting instruction is later than or the same as that of the live broadcast point; and
conduct live video broadcasting based on the streaming media transmission protocol for live broadcast.

12. The non-transitory computer-readable storage medium according to claim 11, wherein the executable instructions, when executed by an online live video player, further cause the online live video player to:
de-multiplex from front key frame of the code stream section, and decode and render from the timing of the broadcast time adjusting instruction, when the timing of the broadcast time adjusting instruction falls within the front and rear key frames of a code stream section of a playback video.

13. The non-transitory computer-readable storage medium according to claim 12, wherein said step of streaming media transmission protocol for broadcast uses the streaming media transmission protocol based on RTMP protocol, and said step of streaming media transmission protocol for playback uses the streaming media transmission protocol based on HTTP protocol.
